(19) United States
(12) Patent Application Publication
(10) Pub. No.: US 2006/0237518 A1
(43) Pub. Date: Oct. 26, 2006

(54) Folder for use as a knee board

(76) Inventor: Josef Hageneder, Steinhaus (AT)

Correspondence Address: WILLIAM COLLARD;COLLARD & ROE, P.C., 1077 NORTHERN BOULEVARD, ROSLYN, NY, 11576, US

(21) Appl. No.: 10/554,017

(22) PCT Filed: Apr. 22, 2004
(86) PCT No.: PCT/AT04/00135

§ 371 Date: Oct. 21, 2005

(30) Foreign Application Priority Data
Apr. 23, 2003 (AT) A 614/2003
Sep. 22, 2003 (AT) A 1494/2003

(51) Int. Cl. B65D 27/00; A47B 23/00; F16M 11/00

(52) U.S. Cl. 229/67.1; 248/174; 108/43

(57) ABSTRACT

In order to provide advantageous constructional conditions in a folder for the use as a knee board with two folder lids (3) which comprise at least one receiver (5, 6) for documents and which are joined with each other by means of at least one joint (1) it is proposed that the joint (1) can be blocked by a latching device (7) which mutually joins the two folder lids (3) with one another.

### FIELD OF THE INVENTION

The invention relates to a folder for the use as a knee board with two folder lids which comprise at least one receiver for documents and which are joined with each other by means of at least one joint.

### DESCRIPTION OF THE PRIOR ART

In order to provide a pilot with the documents for flying a plane in a readily available manner, knee boards are used which are substantially rigid supports placed on the thighs and which are equipped with a receiver such as a clamping device for the respectively required documents. To ensure that the extraction of flight documents from a file can be omitted, it has already been proposed to use the folders per se with the required documents as the knee boards. This leads to difficulties however due to the swivellability of the folder lids because when the folder is rested on the knees the folder remains without any support in its back region and therefore tends to fold together. This inadvertent folding together of the folder lids is prevented in a known folder which can be used as a knee board in such a way that the back of the folder forms a central hinged joint for the folder lids which are connected with the adjacent back parts in a rigid fashion, so that the back parts form a mutually opposite limit stop upon opening the folder which delimits the pivoting apart of the folder lids. If the opened folder is thus placed with the inside downwardly on the thighs, the back parts lying close to one another prevent any further pivoting of the folder lids, which thus form a stable knee support for the flight documents under the given load in the opening sense. This comes with the disadvantage however that during the closure of the folder the flight documents come to lie on the outside of the folder covers.

### SUMMARY OF THE INVENTION

The invention is thus based on the object of providing a folder of the kind mentioned above in such a way that it receives the required flight documents in the conventional manner protected on the inner side of the folder lid and can still be used as a knee board without having to fear any inadvertent inward folding of the folder lids.

This object is achieved by the invention in such a way that the joint can be blocked by a latching device which mutually joins the two folder lids with one another.

By providing a latching device which joins the two folder lids with one another it is simply possible to block the joint for pivoting the folder lids and to prevent an inward folding of the opened folder. This means that the documents can be arranged and stored in a conventional manner between the folder lids without compromising the use of the folder as a knee board. A load-induced inward folding of the folder lids is blocked by the latching device which joins the two folder lids with each other.

The constructional embodiment of the latching device can be provided in different ways. A simple construction is obtained for example in such a way that the latching device comprises a latch with a longitudinal groove into which engage the upper or lower edges of the folder lids. For locking the folder lids in the opened position it is merely necessary to insert the latch onto the upper or lower edges of the folder which are guided in the longitudinal groove of the latch and effectively prevent an inward folding of the folder lids. When not in use, such a latch can be inserted onto a lateral edge of a folder lid.

In another embodiment of the latching device, it is possible to use the latch which extends transversally to the back and rests on the folder lids. It engages in insertion guides of the folder lids or can be joined with the folder lids by snap fasteners or Velcro fasteners, so that the folder lids are supported against pivoting on this latch.

In order to prevent loose latches, the latching device can also consist of upper or lower edge brackets which extend beyond the folder lids and are joined in an articulated manner along their longitudinal edges with each other and with the folder and are subdivided in an articulated way according to the pivoting joint(s) of the folder lids. When such edge brackets are folded against the folder lid or the back between the folder lids, they therefore rest on said folder parts. The pivoting capabilities of the folder lids is not obstructed by the articulated subdivision of the edge brackets. If the edge brackets are unfolded in the opened position of the folder into a transversal position relative to the common plane of the folder lids and the back, the unfolded edge brackets will block the mutual pivoting of the folder lids despite their articulated subdivision because the axis of the articulated subdivision of the edge brackets extends transversally to the axes of the hinged joints of the folder lids. It is therefore merely necessary to ensure that the unfolded transversal position of the edge brackets is fixed, which can be achieved in a simple manner by providing two rows of brackets because the outer row of brackets of the edge brackets forming a triangular structure can be held on the folder lids in a non-displaceable manner by a Velcro fastener for example.

Another embodiment of a latching device is obtained when a pivoting latch is provided which overlaps the back between the folder lids in the latching position and rests on the two folder lids and is twisted from an idle position to a latching position. Said pivoting latch can be arranged as a single-arm lever and can be held on one of the two folder lids. When the folder is opened, the pivoting latch can be pivoted over the back against the other folder lid and can be latched there. It is recommended to provide a latching bracket in the region of the back too, behind which the pivoting latch is swivelled. The pivoting latch can also be configured as a two-arm lever. In this case it is held on the back of the folder, so that the pivoting latch extends in the idle position parallel to the back and is twisted from this idle position to a transversal position in which the latch is provided with the two folder lids.

Receiving pockets can be provided on the folder lids for latching the pivoting latch, into which the pivoting latches engage. Depending on the configuration of the pivoting latch as a single-arm or two-arm lever, the pocket arrangement is provided on one or both folder lids. Instead of receiving pockets into which engage the free ends of the pivoting latches, the respective pivoting latch can be provided at its free end or at its free ends with a receiving hook for a latching pin provided on the folder lid which is used for the latching between the pivoting latch and the folder lid. Especially advantageous constructional conditions are obtained in this connection when the latching pin forms an undercut for the engagement of the receiving hook, because in this case the axial lifting of the pivoting latch from the latching pin is prevented.

A further constructional possibility for a latching device is obtained when a toggle lever is provided which bridges the back, is linked to the two folder lids and comprises in the latched position an over-center toggle point position limited by a stop. As a result of the stop-limited over-center toggle position of the toggle lever, a secure latching of the folder lid against an inadvertent folding of the opened folder is ensured. For detaching the latching it is necessary to swivel the toggle lever by hand from the over-center toggle position before the folder lids can be folded together.

A further embodiment of a latching device is characterized in that it comprises a pivoting disk which is held on the back and is linked via a guide each to the two folder lids and that the guides assume an over-center toggle position in the stop-limited latching position. A secure latching of the folder lids in the opened position is ensured in this case too. However, the guides linked to a pivoting disk lead to spherical links in order to allow taking part in the rotary movement about the disk axis on the one hand and performing the pivoting movement of the folder lids about their pivoting joints on the other hand.

The described latching devices are especially intended for folders with an undivided back, to which the folder lids are linked in the conventional manner via film hinges. It is understood that it is principally also possible to use folders with a back comprising a central pivoting joint for the folder lids. In such an embodiment, the back parts which are joined in a rigid manner with the folder lids form a mutual stop in the opened position of the folder. The latching device can consist in such a folder configuration of a spring-loaded catch hook which is held on the outside of the folder lid and latches into a latching opening in the other folder lid.

In another embodiment it can be provided that at least two cooperating joint parts of the two folder lids form a latching device for the opened position of the folder lids with at least one projecting latching nose on the one joint part and with a latching recess receiving the latching nose on the other joint part, with one of the two latching parts forming the latching device being held in a displaceable manner relative to the other one and being pressurized by a spring in the latching sense. A simple construction is obtained, because only at least two joint parts each associated with a folder lid carry the latching device. It merely needs to be ensured that there is a mutual displacement of the latching parts in order to enable the release of the latching device. As a result of the spring loading in the latching sense, the latching device latches automatically upon opening the folder when the opened position of the folder lids is reached. The spring loading of the latching parts in latching engagement prevents any inadvertent detachment of the latching device.

The latching parts can be provided mutually radially displaceable with respect to the joint shaft. Especially simple constructional conditions are obtained however when the latching nose on the one joint part projects in the axial direction against the latching recess on the other joint part, so that for latching and unlatching the latching parts themselves can be displaced in the axial direction relative to one another. Although it is possible to hold one of the joint parts of the latching device cooperating in pairs in an axially displaceable manner relative to the associated folder lid, considerably simpler constructional conditions are obtained when the folder lids displaceable against one another against the spring force in the direction of the joint shaft carry the joint parts in a non-displaceable way and are therefore displaced against one another in the direction of the joint shaft during latching and unlatching.

The hinged joint between the folder lids can be provided with a different configuration. If the joint parts consist of hinge sleeves held on a common hinge shaft, the latching recesses and the latching noses can be shaped as recesses and noses on the face side of the hinge sleeves, with a coil spring being provided between two hinge sleeves of the two folder lids, which coil spring encloses the hinge shaft and which exerts a pressure on the hinge sleeves of the two folder lids in the latching sense of the latching device. Another possibility of the formation of a joint is obtained when the joint parts consist of joint disks on the face side which are each joined via a joint shaft stub and which form on their mutually facing sides the axially projecting latching nose or latching recess for the latching nose. For the spring pressurization of the respective inner hinge disk, the shaft stubs supported on the outer hinge disks can displaceably penetrate the contacting inner hinge disk and form with the inner projecting end an abutment for a pressure spring resting on the inner hinge disk.

### BRIEF DESCRIPTION OF THE DRAWINGS

The subject matter of the invention is shown in the drawings by way of example, wherein:

FIG. 1 shows a folder in accordance with the invention in a top view of the inside of the opened folder;

FIG. 2 shows an illustration corresponding to FIG. 1 of an embodiment of a folder in accordance with the invention;

FIG. 3 shows a further embodiment of a folder in accordance with the invention;

FIG. 4 shows a sectional view along line IV—IV in FIG. 3 on an enlarged scale;

FIG. 5 shows a top view of the inner side of an opened folder with a constructional variant of the latching device;

FIG. 6 shows a representation corresponding to FIG. 5 of a further embodiment of a folder with a latching device in accordance with the invention;

FIG. 7 shows a folder in accordance with the invention in a top view of the opened folder with a latching device having a two-arm lever;

FIG. 8 shows the folder according to FIG. 7 in sections in the region of the back in a front view on an enlarged scale.

FIG. 9 shows a further constructional variant of a folder in accordance with the invention with a latching device in the form of a toggle lever in a top view of the opened folder;

FIG. 10 shows the folder according to FIG. 9 in sections in the back region in a front view on an enlarged scale;

FIG. 11 shows a representation according to FIG. 10 of the folder according to FIG. 9, but in the closed state;

FIG. 12 shows a further embodiment of a folder in accordance with the invention in a top view of the inside of the opened folder;

FIG. 13 shows the folder according to FIG. 12 in sections in the back region in a front view with folded folder lids on an enlarged scale;

FIG. 14 shows a folder in accordance with the invention with a back subdivided in the middle in an articulated way in a top view of the opened folder;

FIG. 15 shows the folder according to FIG. 14 in sections in the back region in a front view on an enlarged scale;

FIG. 16 shows a further embodiment of a folder in accordance with the invention in a top view of the inside of the opened folder;

FIG. 17 shows a sectional view along line II—II of FIG. 1 on an enlarged scale;

FIG. 18 shows an embodiment of a folder in accordance with the invention in sections in the region of the front joint parts in a partly elevated top view on an enlarged scale of the inside of the opened folder latched in the opened position, and

FIG. 19 shows a sectional view along line IV—IV of FIG. 3 on an enlarged scale.

### DESCRIPTION OF THE PREFERRED EMBODIMENTS

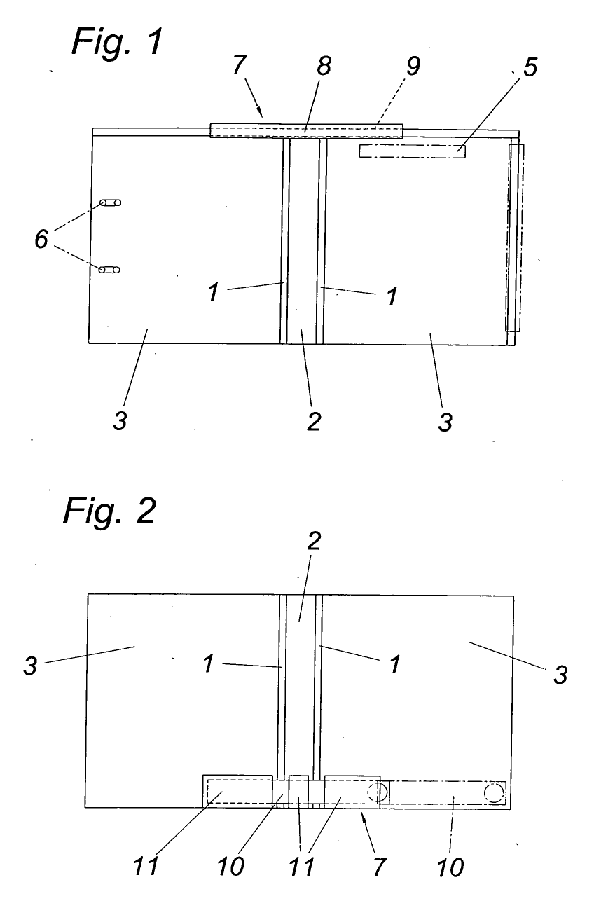

According to the embodiments according to FIGS. 1 to 13, the illustrated folders each comprise two folder lids 3 which are linked by means of joints 1, and film hinges in particular, to a back 2, which lids carry receivers 5 and 6 for documents on their insides in the conventional manner. The receiver 5 can be configured as a clamping holder and the receiver 6 as a fixing bracket for perforated papers, as is indicated in FIG. 1 with the dot-dash line. The receivers 5 and 6 are not shown in the other illustrations for reasons of clarity.

In order to enable the latching of such a folder in the opened state, a latch is provided which joins the two folder lids 3 with each other beyond the back 2. In accordance with FIG. 1, the latching device 7 consists of a bar 8 which is U-shaped in its cross section and can be inserted into the preferably reinforced upper edge of the folder lid 3 and the back 2, so that the edges of the folder lid 3 and the back 2 engage in the longitudinal groove 9 obtained between the legs of the bar 8. When the folder is to be closed, the bar 8 withdrawn from the upper edge of the folder can be inserted into a side edge of the folder lid 3, as is indicated with the dot-dash line in FIG. 1.

According to FIG. 2, a bar 10 is provided which cooperates with insertion guides 11 on the inside of the folder lid 3 and back 2. In the opened state of the folder, the bar 10 can be inserted into the insertion guides 11 in the latching position shown with the unbroken lines. The opened position of the bar 10 indicated by the dot-dash line allows an unhindered folding of the folder lids 3. Since it is relevant in accordance with the invention to join the two folder lids 3 with each other beyond the back 2 in order to block the pivoting joints 1, the insertion guides 11 can also be replaced by snap fasteners or Velcro fasteners, with the help of which the bar 10 can be joined with the folder lids 3.

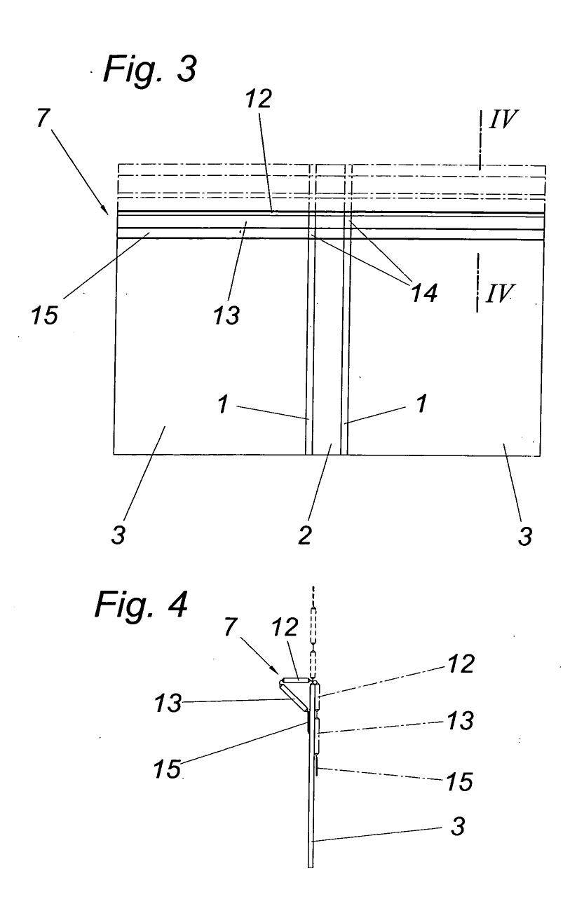

The embodiment according to FIGS. 3 and 4 shows a latching device 7 in the form of edge brackets 12, 13 which are linked to the upper edge of the folder 3 by means of film hinges and are additionally subdivided in an articulated manner according to the pivoting joints 1. The joints corresponding to the pivoting joints 1 of folder 3 are designated with reference numeral 14. When the edge brackets 12, 13 are bent against the folder lid 3 (as is indicated in FIG. 4 with the dot-dash line), the folder can be opened and closed in an unhindered manner along the pivoting joints 1. If on the other hand the edge bracket 12 which is linked directly to the folder lids 3 is pivoted upwardly to a transversal position (as is shown in FIG. 4 with the unbroken lines), this edge bracket 12 blocks the folding of the opened folder lids 3 because the joints 14 extend transversally to the pivoting joints 1. The additional edge bracket 13 is used for supporting the transversal edge bracket 12 and can be fixed with the help of a Velcro fastener 15 to the folder lids 3, so that the edge bracket 12 is supported in the form of a triangular structure against the folder lids 3.

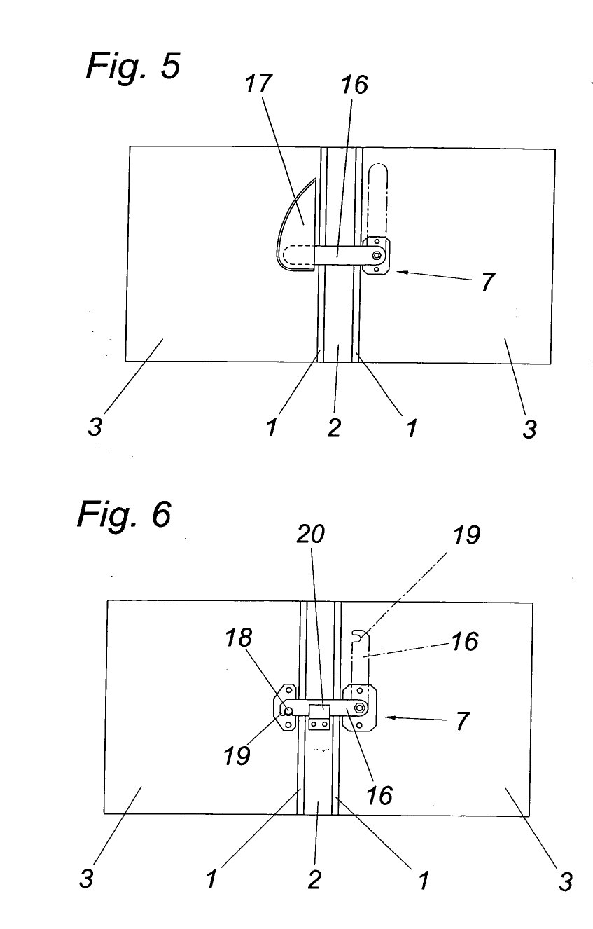

According to the embodiment in accordance with FIG. 5, the latching device 7 consists of a pivoting bar 16 which is arranged as a single-arm lever and is held in a pivoting manner on a folder lid 3. Said pivoting lever 16 engages in the latched position (shown in the unbroken lines) beyond the back 2 into a receiving pocket 17 on the opposite folder lid 3 in order to thus block the pivoting joints 1. The pivoting bar 16 is pivoted in the opened position to an idle position which is parallel to back 2, which is shown with the dot-dash line.

According to FIG. 6, a single-arm lever 16 is also provided which does not engage in a receiving pocket, but cooperates with a latching pin 18 on the opposite folder lid 3. For this purpose the pivoting bar 16 forms a receiving hook 19 at its free end, which hook preferably engages in an undercut of the latching pin 18. In addition, the pivoting bar 16 grasps underneath a latching bracket 20 arranged on the back 2.

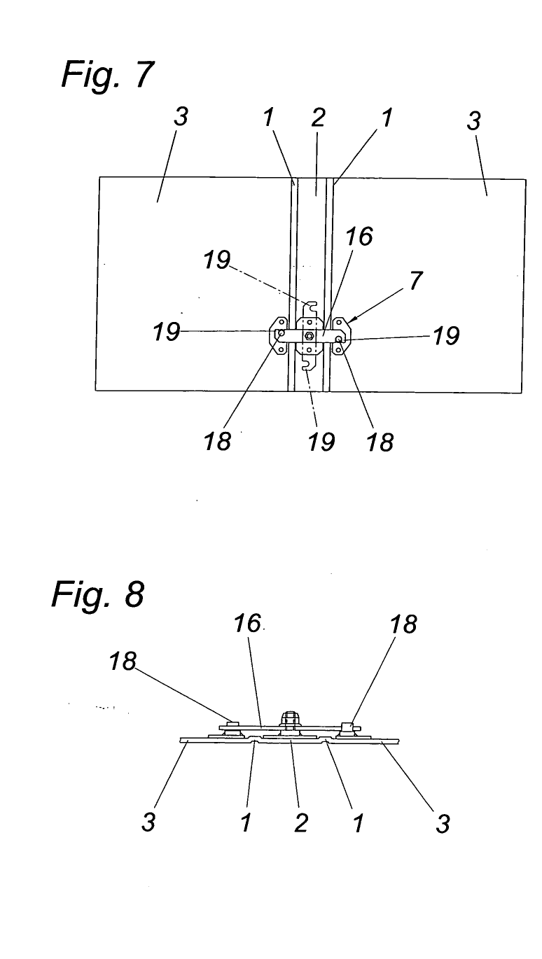

The latching device 7 according to FIGS. 7 and 8 comprises a pivoting bar 16. Said pivoting bar 16 is arranged as a two-arm lever which is held on the back 2. It forms at the two free ends a receiving hook 19 each for latching pins 18 arranged on the two folder lids 3. This constructional embodiment allows a secure latching of the opened folder with a comparatively low amount of effort in order to use the same as a knee board.

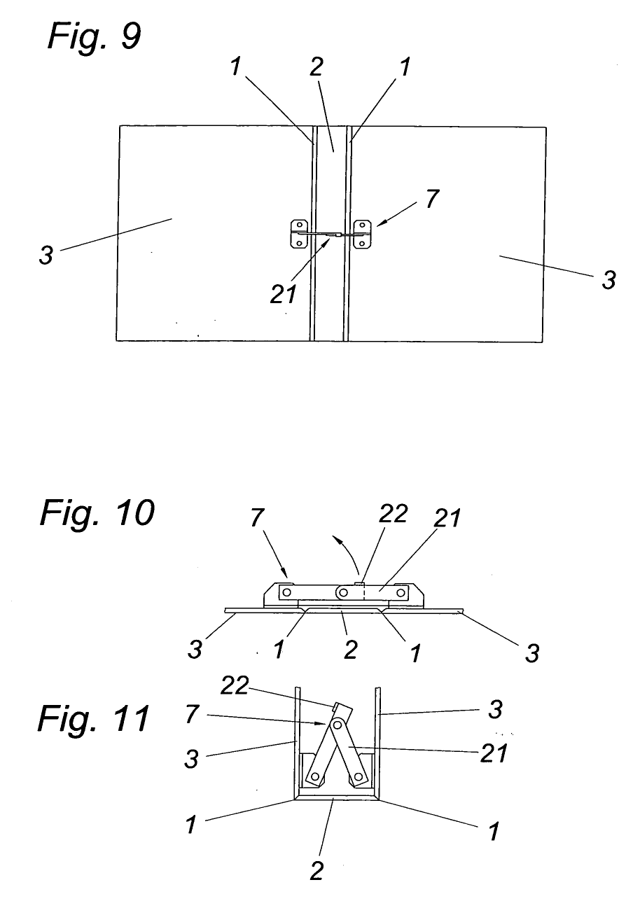

The latching device 7 according to FIGS. 9 to 11 consists of a toggle lever 21 which is held on both folder lids 3 and bridges the back 2. In the latching position as shown in FIG. 10, the toggle lever 31 assumes a over-center position which is limited by a limit stop, so that on trying to open the folder lids against one another, the toggle lever 21 is pressed with increased force to the limit stop position. The over-center position needs to be overcome for opening the toggle lever 21, such that the one of the two levers 21 is swivelled upwardly by means of the stop 22, as is indicated in FIG. 10 by an arrow. After the unlatching of the toggle lever 21 the folder lids 3 can be closed, as shown in FIG. 11.

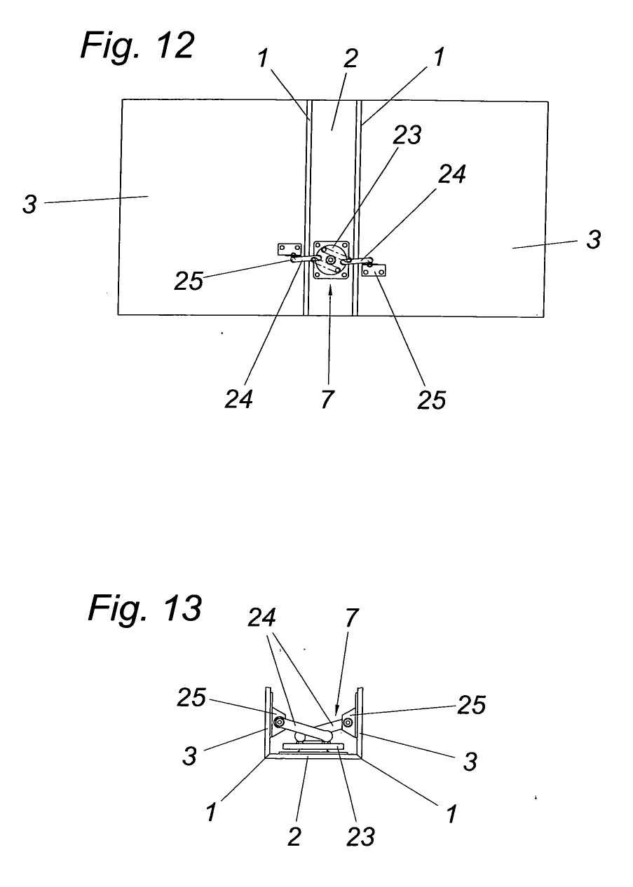

A further construction of the latching device 7 is shown in FIGS. 12 and 13. According to this embodiment, the latching device 7 comprises a pivoting disk 23 which is held on the back 2 and is connected via guides 24 with the folder lids 3. The linkage of the guides 24 occurs both on the pivoting disk 23 as well as the bearings 25 of the folder lids 3 by way of spherical joints because the guides 24 need to be turned not only about the axis of the pivoting disk 23 but also about the pivoting joints 1 of the folder lids 3. In the latched position according to FIG. 12, the guides 24 assume a stop-limited over-center position with respect to the rotational axis of the pivoting disk 23. The attempt to close the folder lid 3 entails a torque on the pivoting disk 23 via the guides 24, which torque presses the pivoting disk 23 against the rotary stop. For unlatching purposes it is therefore necessary that the pivoting disk 23 needs to be turned by hand from the over-center position before the folder lids 3 can be closed according to FIG. 13.

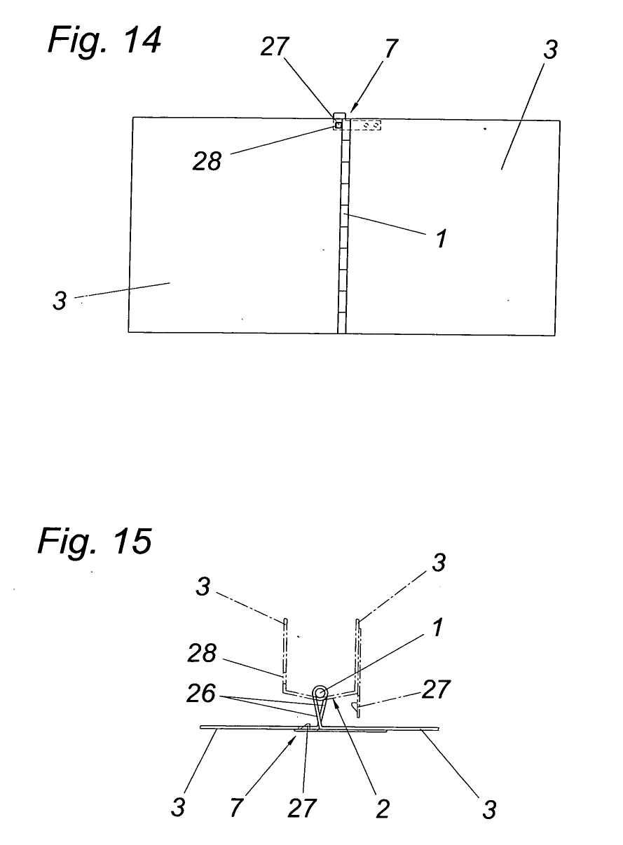

According to FIGS. 14 and 15, the back 2 of the folder is divided by a central pivoting joint 1. The folder lids 3 are rigidly connected with the adjacent back parts 26. When the folder is opened, the two back parts 26 are swivelled against each other according to FIG. 15 until they meet each other in the opened position. When the folder lids 3 are joined with each other in this stop-limited opened position by way of a spring-loaded catch hook 27 which engages in a respective latching opening 28 in the opposite folder lid 3, the pivoting joint 1 can also be blocked in the opened position in order to enable placing the folder as a knee board on the thighs with the insides of the folder lids 2 facing upwardly.

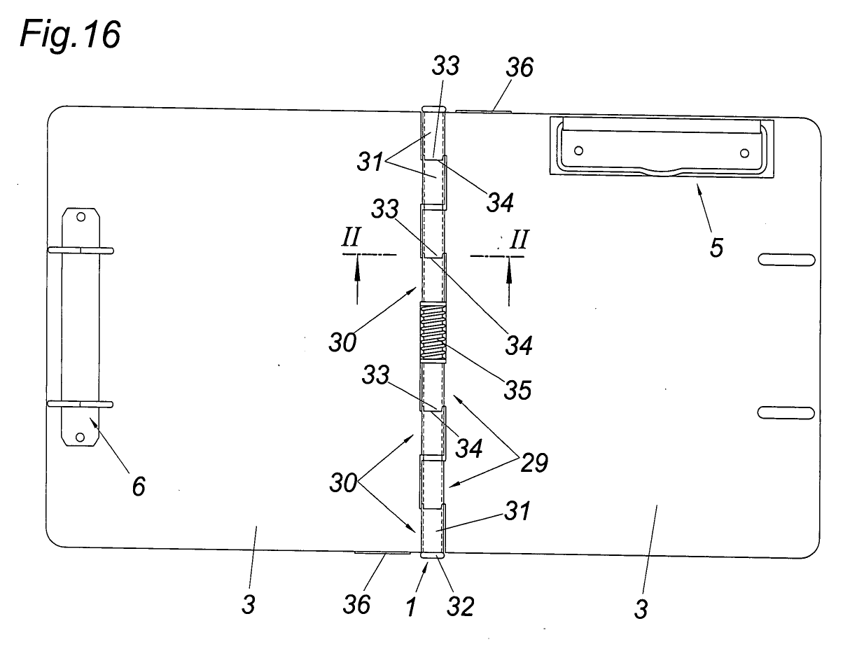

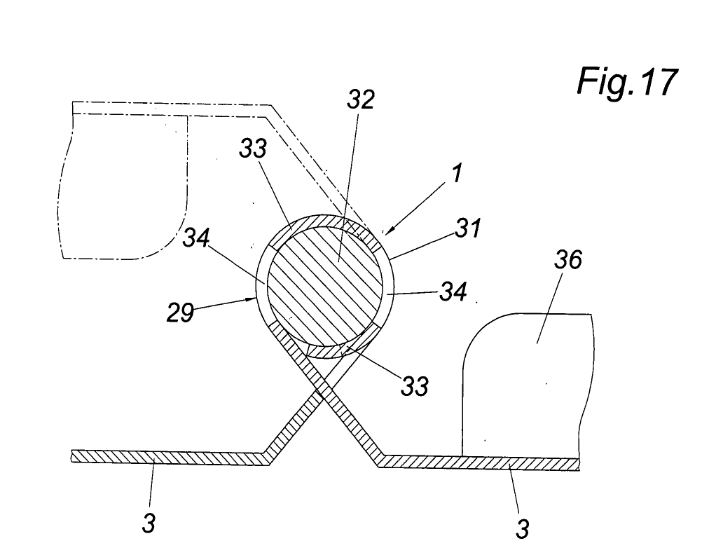

According to FIGS. 16 and 17, the folder lids 3 of a folder are joined with each other by way of a hinge joint 1 whose joint parts 29 and 30 consist of a hinge sleeves 31 which are associated in an alternating manner with the two folder lids 3 and which are penetrated by a common hinge shaft 32. The arrangement is made in such a way that the two folder lids 3 are held in a displaceable manner against each other on the hinge sleeves 31 in a stop-limited fashion in the direction of the joint shaft 32. This is necessary to latch the two folder lids 3 in their illustrated opened position against each other by way of a latching device which is formed by the hinge sleeves 31 themselves and consist of axially projecting latching noses 33 and latching recesses 34 for receiving said latching noses 33. The latching noses 33 and the latching recesses 34 are formed by recesses and projections of the hinge sleeves 31 on the face side. They engage into each other in the manner of a claw coupling and block the mutual twisting of the latched folder lids 3. The latching position is secured by a coil spring 35 enclosing the hinge shaft, which spring rests between two hinge parts 29 and 30 of the two folder lids 3. When the latching position of the folder lids 3 is to be released, the two folder lids 3 are displaced against one another against the force of spring 35 until the latching noses 33 axially emerge from the latching recesses 34 and release the mutual twisting of the folder lids 3 about the hinge shaft 32. The folder can then be closed, as is indicated in FIG. 17 in a dot-dash line. If the latching noses 33 and the latching recesses 34 are arranged on the adjacent face sides of adjacent hinge sleeves 31 against one another under a respective angular offset, it is possible to latch not only the opened position but also the closed position of the folder with the help of the latching device. An automatic release of the latch can be set via the inclination of the flanks of the latching noses 33 and latching recesses 34 when the folder lids 3 are subjected to a respective torque.

For the purpose of easier actuation of the latching device, the folder lids 3 can be provided with projecting actuating brackets 36 which facilitate the mutual displacement of the folder lids 3 along the hinge shaft 32. Moreover, the folder lids 3 can be provided with the usual receivers 5 and 6 for documents.

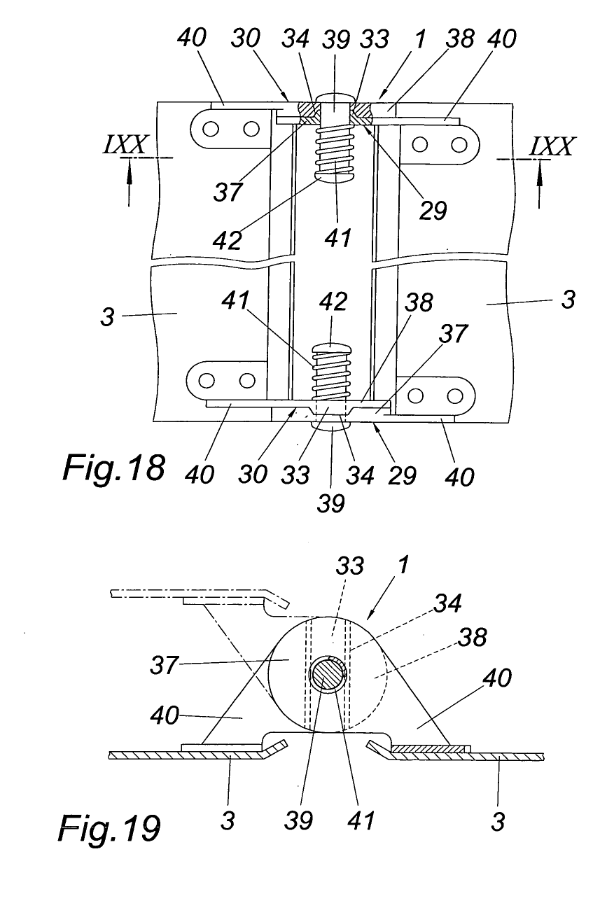

In contrast to the embodiment according to FIGS. 16 and 17, the hinge joint 1 consists according to the embodiment of a folder according to FIGS. 18 and 19 of the joint parts 29 and 30 which are formed by joint disks 37 and 38 on the face side and are each penetrated by joint shaft stub 39. Said joint disks 37, 38 which are joined by way of fastening brackets 40 with the associated folder lids 3 comprise on their mutually facing sides axially projecting latching noses 33 and latching recesses 34 receiving said latching noses 33, so that a latching device for the opened position and also for the closed position of the folder is obtained through the latching noses 33 engaging in the latching recesses 34. The latching position is ensured by pressure springs 41 which rest on the one hand on a head 42 of the joint shaft stubs 39 penetrating the respective inner joint disk 37 or 38 and on the other hand on the inner joint disk 37 or 38, as is shown especially in FIG. 18. When the two folder lids 3 are displaced against one another in the direction of the joint shaft stubs 39, the latching noses 33 emerge from the latching recesses 34 of the joint disks 47 and 38 cooperating in pairs, and allow the mutual twisting of the folder lids 3.

1. A folder for the use as a knee board with two folder lids which comprise at least one receiver for documents and which are joined with each other by means of at least one joint, wherein the joint (1) can be blocked by a latching device (7) which mutually joins the two folder lids (3) with one another.

2. A folder according to claim 1, wherein the latching device (7) comprises a latch (8) with a longitudinal groove (9) into which engage the upper or lower edges of the folder lids (3).

3. A folder according to claim 1, wherein the latching device (7) comprises a bar (10) which extends transversally to the joint shaft, rests on the folder lids (3) and engages in insertion guides (11) of the folder lids (3) or can be joined with the folder lids by snap fasteners or Velcro fasteners.

4. A folder according to claim 1, wherein the latching device (7) consists of upper or lower edge brackets (12, 13) which extend beyond the folder lids (3) and are joined in an articulated manner along their longitudinal edges with each other and with the folder, and are subdivided in an articulated way according to the pivoting joint(s)(1) of the folder lids (3).

5. A folder according to claim 1, wherein the latching device (7) consists of a pivoting latch (16) which rests in the latching position on the two folder lids (3).

6. A folder according to claim 5, wherein the pivoting latch (16) is arranged as a single-arm lever and is held on one of the two folder lids (3).

7. A folder according to claim 5, wherein the pivoting latch (16) which is arranged as a two-arm lever is held on a back (2) joining the folder lids (3).

8. A folder according to claim 5, wherein the pivoting latch (16) can be pivoted with its free end(s) into a receiving pocket (17).

9. A folder according to claim 5, wherein the pivoting latch (16) is provided at its free end(s) with a receiving hook (19) for a latching pin (18) provided on the folder lid (3).

10. A folder according to claim 9, wherein the latching pin (18) forms an undercut for the engagement of the receiving hook (19).

11. A folder according to claim 1, wherein the latching device (7) consists of a toggle lever (21) which bridges the back (2), is linked to the two folder lids (3) and comprises in the latched position an over-center toggle position limited by a stop.

12. A folder according to claim 1, wherein the latching device (7) comprises a pivoting disk (23) which is held on the back (2) joining the two folder lids (3) and is linked via a guide (24) each to the two folder lids (3), and that the guides (24) assume an over-center toggle position in the stop-limited latching position of the pivoting disks (23).

13. A folder according to claim 1, wherein a back (2) joining the two folder lids comprises a central pivoting joint (1) for the folder lids (3), the back parts (26) rigidly joined with the folder lids (3) form a mutual stop in the opened position of the folder and that the latching device (7) consists of a spring-loaded catch hook (27) which is held on the outside of a folder lid (3) and latches into a latching opening (28) in the other folder lid (3).

14. A folder according to claim 1, wherein at least two cooperating joint parts (29, 30) of the two folder lids (3) form a latching device for the opened position of the folder lids (3) with at least one projecting latching nose (33) on the one joint part (29, 30) and with a latching recess (34) receiving the latching nose (33) on the other joint part (30, 29), with one of the two latching parts (33, 34) forming the latching device being held in a displaceable manner relative to the other one and being pressurized by a spring (35, 41) in the latching sense.

15. A folder according to claim 14, wherein the latching nose (33) projects on the one joint part (29, 30) against the latching recess (34) on the other joint part.

16. A folder according to claim 15, wherein the folder lids (3) which are displaceable against one another against the spring force in the direction of the joint shaft (32) carry the hinge parts (29, 30) in a non-displaceable manner.

17. A folder according to the claim 15, wherein the joint parts (29, 30) consist of hinge sleeves (31) held on a common joint shaft (32), the latching recesses (34) and the latching noses (33) are formed as recesses and noses on the face side of the hinge sleeves (31), and a coil spring (35) is provided between two hinge sleeves (31) of the two folder lids (3), which coil spring encloses the joint shaft (32).

18. A folder according to claim 15, wherein the joint parts (29, 30) consist of joint disks (37, 38) on the face side which are each jointed via a joint shaft stub (39) and which form on their mutually facing sides the axially projecting latching nose (33) or latching recess (34) for the latching nose, and that the joint shaft stubs (39) supported on the outer of the two joint disks (37, 38) displaceably penetrate the contacting inner joint disk (37 or 38) and form with the inner projecting end an abutment for a pressure spring (41) resting on the inner joint disk (37 or 38).
